(19) United States
(12) Patent Application Publication
(10) Pub. No.: US 2007/0097563 A1
(43) Pub. Date: May 3, 2007

(54) Information processing apparatus and power supply control method

(75) Inventors: Masahiko Hagiwara, Ome-shi (JP); Shizuo Morioka, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/584,542

(22) Filed: Oct. 23, 2006

(30) Foreign Application Priority Data
Oct. 31, 2005 (JP) 2005-317741

(51) Int. Cl. H02H 7/00

(52) U.S. Cl. 361/18

(57) ABSTRACT

According to one embodiment, an information processing apparatus includes a first DC-DC converter which outputs power to a first device and detects a first current value and a first voltage value of the first DC-DC converter. A second DC-DC converter outputs power to a second device and detects a second current value and a second voltage value of the second DC-DC converter. A first PWM control circuit supplies a first PWM signal to the first DC-DC converter. A second PWM control circuit supplies a second PWM signal to the second DC-DC converter. An operation unit controls a pulse width of the first PWM signal based on the first current value and the first voltage value at a first frequency, and controls a pulse width of the second PWM signal based on the second current value and the second voltage value at a second frequency lower than the first frequency.

### CROSS-REFERENCE TO RELATED APPLICATIONS

This application is based upon and claims the benefit of priority from Japanese Patent Application No. 2005-317741, filed Oct. 31, 2005, the entire contents of which are incorporated herein by reference.

### BACKGROUND

1. Field

One embodiment of the invention relates to an information processing apparatus using a plurality of DC-DC converters and PWM control circuits and to a power supply control method.

2. Description of the Related Art

Various multiple-output power supplies are developed which output a plurality of kinds of stabilized direct current power. In addition, various stabilized direct-current power supplies are developed which perform PWM control on DC-DC converters (for example, refer to Japanese Patent Application Publications (KOKAI) No. 2001-268909 and No. H10-248238).

Recently, so-called multiple-output digital power supplies have been developed which perform PWM control on a plurality of DC-DC converters by using a DSP (Digital Signal Processor). In a DC-DC converter, a feedback loop (control loop) exists which monitors and controls an output voltage in order to obtain a desired output voltage from an input voltage. The DSP performs the process of the feedback loop with respect to the output of the DC-DC converter. In this process, a process is performed which controls the pulse width (that is, duty ratio (on-duty)) of a PWM signal to be supplied (applied) to the DC-DC converter based on the value of the output voltage, the value of the output current (current which flows to a load), or the values of both output voltage and output current of the DC-DC converter by the feedback loop. This control by the DSP has been conventionally performed on the above-mentioned DC-DC converters (that is, on a PWM control circuit which performs PWM control on the DC-DC converters) equally (at the same frequency) in a predetermined order in a predetermined cycle.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of an information processing apparatus using a multiple-output power supply unit according to an embodiment;

FIG. 2 is an exemplary diagram showing the internal structure of the multiple-output power supply unit according to the embodiment; and

FIG. 3 is an exemplary flowchart for explaining exemplary control frequency setting of the multiple-output power supply unit according to the embodiment.

### DETAILED DESCRIPTION

Various embodiments according to the invention will be described hereinafter with reference to the accompanying drawings. In general, according to one embodiment of the invention, there is provided an information processing apparatus including: a first DC-DC converter which outputs power to a first device and detects a first current value and a first voltage value of the first DC-DC converter; a second DC-DC converter which outputs power to a second device and detects a second current value and a second voltage value of the second DC-DC converter; a first PWM control circuit which supplies a first PWM signal to the first DC-DC converter; a second PWM control circuit which supplies a second PWM signal to the second DC-DC converter; and an operation unit configured to control a pulse width of the first PWM signal based on the first current value and the first voltage value at a first frequency, and control a pulse width of the second PWM signal based on the second current value and the second voltage value at a second frequency, the first frequency being higher than the second frequency.

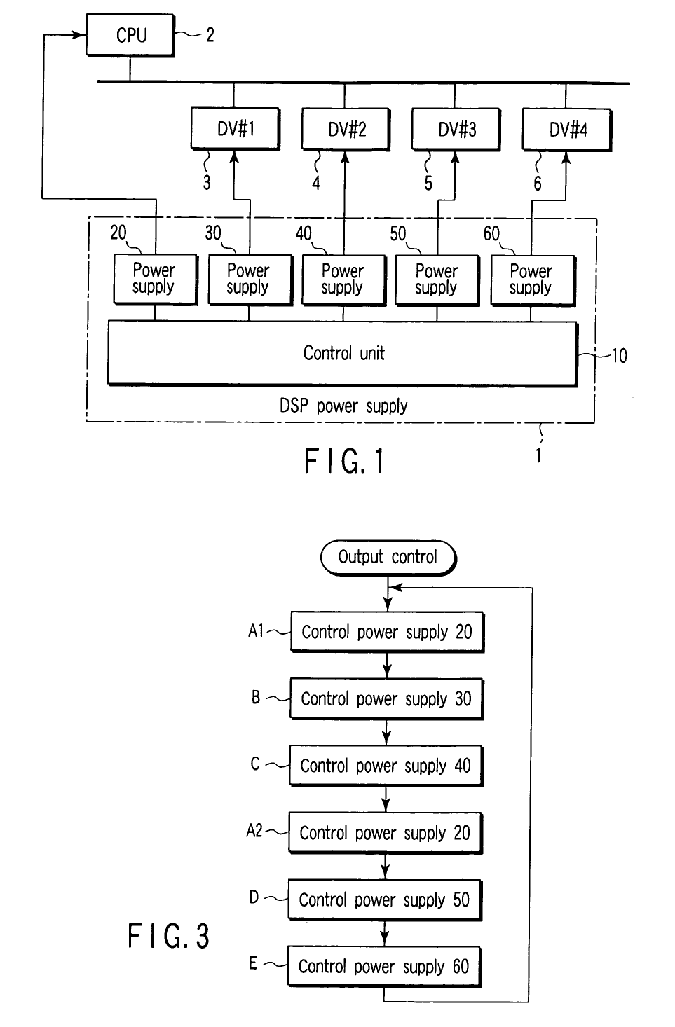

FIG. 1 shows a partial system structure of an information processing apparatus using a multiple-output power supply unit according to an embodiment.

A personal computer, which realizes an information processing apparatus, includes a CPU 2 which is in charge of system control, and a plurality of kinds of system component devices (DV#1, DV#2, DV#4) 3, 4, . . . , 6 which perform various operations under control of the CPU 2. These devices are, for example, a graphic controller, a communication controller, an embedded controller, a bus bridge, or the like.

Additionally, the personal computer is provided with a multiple-output power supply unit (a digital power supply unit using a DSP) 1. The multiple-output power supply unit 1 includes a control unit 10 and power supplies 20, 30, 40, 50 and 60. The output power of the power supply 20 is supplied to the CPU 2. The output power of the power supplies 30, 40, 50 and 60 is supplied to the devices (DV#1, DV#2, DV#4) 3, 4, . . . , 6.

The multiple-output power supply unit 1 performs control of the pulse width by a feedback loop with respect to the power supply 20 for the CPU 2, requiring a fast response, at a frequency twice that for the other power supplies 30, 40, 50 and 60. Accordingly, the cross-over frequency of the feedback loop of the power supply 20, which supplies power to the CPU2, becomes higher than those of the power supplies 30, 40, 50 and 60. Thus, it is possible to realize a multiple-output stabilizing power supply which uses a low-speed DSP and is able to respond to a rapid change of load.

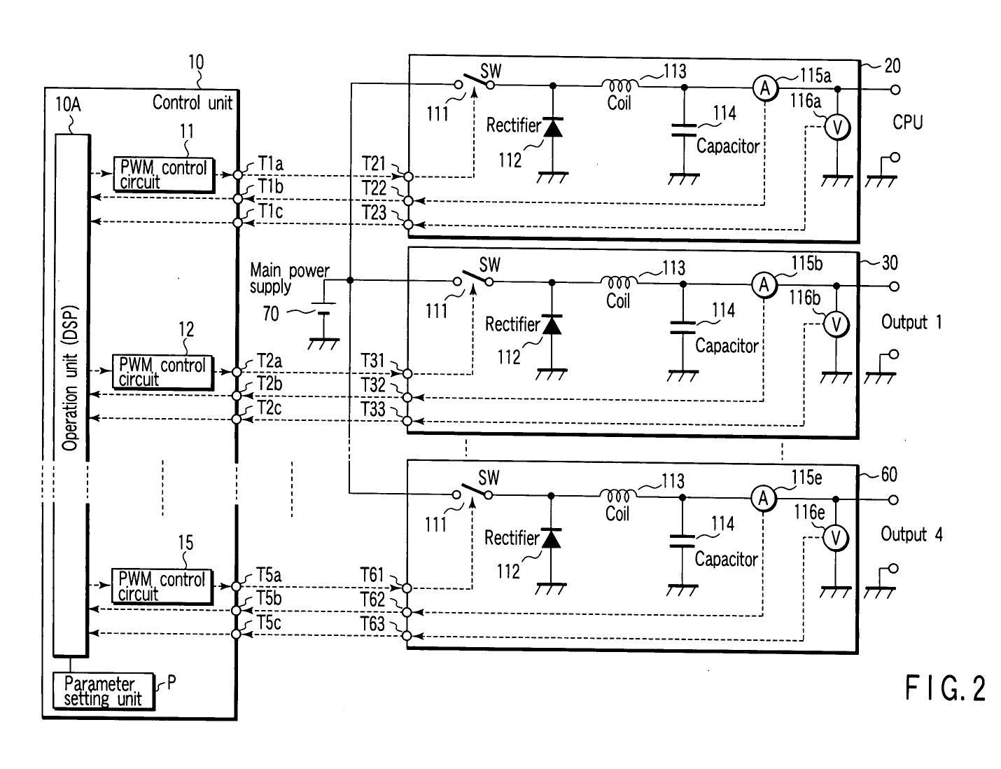

FIG. 2 shows a more specific structure of the multiple-output power supply unit 1 shown in FIG. 1. In FIG. 2, those units corresponding to the units shown in FIG. 1 are designated by the same reference numerals, and a description thereof is omitted.

The multiple-output power supply unit 1 shown in FIG. 2 includes, as shown in FIG. 1, the control unit 10 and the power supplies 20, 30, 40, 50 and 60. It should be noted that, in FIG. 2, the power supplies 40 and 50 are not shown.

The control unit 10 includes an operation unit 10A, which is realized by a DSP, and a plurality of PWM control circuits 11, 12, . . . , 15 corresponding to the power supplies 20, 30, . . . , 60, respectively.

The operation unit 10A calculates, for the feedback loops of the power supplies 20, 30, . . . , 60, the pulse widths of PWM signals which are output from the PWM control circuits 11, 12, . . . , 15 based on the values of current detecting units 115a, 115b, . . . , 115e and voltage detecting units 116a, 116b, . . . , 116e, respectively, at the above-mentioned control frequency. Based on the calculated values, the operation unit 10A controls the output pulse widths (on-duty) of the PWM signals which are output from the PWM control circuits 11, 12, . . . , 15.

The power supplies 20, 30, . . . , 60 include respective DC-DC converters, the current detectors 115a, 115b, . . . , 115e, and the voltage detectors 116a, 116b, . . . , 116e, respectively. Each of the DC-DC converters includes a switching unit 111, a rectifier 112, a coil (inductor) 113, a capacitor 114, etc.

Each of the current detectors 115a, 115b, . . . , 115e is provided in an output current path of the corresponding DC-DC converter. Each of the voltage detectors 116a, 116b, . . . , 116e is provided at an output end of the corresponding DC-DC converter.

The DC-DC converter uses a main power supply 70 as an input power supply, and outputs, to a power output terminal, an input power supply voltage by, for example, decreasing the voltage thereof.

As for controlling of the pulse width with respect to each of the power supplies 20, 30, 40, 50 and 60 in accordance with the set frequency in each control loop, the description is given above with reference to FIG. 1. Thus, the description is not repeated.

The control unit 10 is provided with PWM signal output terminals T1a, T2a, T3a, T4a and T5a, and control input terminals T1b, T2b, T3b, T4b, T5b, T1c, T2c, T3c, T4c and T5c for forming feedback loops.

The power supplies 20, 30, 40, 50 and 60 are provided with PWM signal input terminals T21, T31, T41, T51 and T61, current value output terminals T22, T32, T42, T52 and T62, and voltage value output terminals T23, T33, T43, T53 and T63, respectively, for similarly forming feedback loops.

Here, it is assumed that the power supply 20 is a power supply unit supplying an operating power to a load which requires fast response in the feedback loop. An example of the load is a CPU. In addition, it is assumed that the power supplies 30, 40, 50 and 60 are power supplies which supply operating power to devices which operate under control of the CPU. Examples of the devices are I/O devices, peripheral devices, etc.

The PWM signal output terminal T1a of the control unit 10 is coupled to the PWM signal input terminal T21 of the power supply unit (CPU 1 power supply) 20. The current value output terminal T22 and the voltage value output terminal T23 of the power supply 20 are coupled to the control input terminals T1b and T1c, respectively. In this manner, the feedback loop of the power supply 20 is formed.

In addition, the PWM signal output terminal T2a of the control unit 10 is coupled to the PWM signal input terminal T31 of the power supply 30 (output 1 power supply). The current value output terminal T32 and the voltage value output terminal T33 of the power supply 30 are coupled to the control input terminals T2b and T2c of the control unit 10, respectively. In this manner, the feedback loop of the power supply unit 30 is formed.

Similarly, the feedback loops of the power supplies 40, 50 and 60 are formed between the control unit 10 and the power supplies 40, 50 and 60 (output 4 power supply), respectively.

The control unit 10 divides the PWM control circuits 11, 12, . . . , 15 into a predetermined number of groups, and includes a parameter setting unit (frequency setting unit) P for setting a different control frequency (frequency of control by a control loop) for each of the groups. In accordance with a control parameter which is set to the parameter setting unit P, the control unit 10 sets a control frequency specified by the parameter to the power supplies which belong to a group specified by the parameter, and performs control by the feedback loop based on the control frequency. The parameter which is set to the parameter setting unit P can be varied (updated) arbitrarily. In the case where no parameter is set to the parameter setting unit P, pulse width control by the feedback loops is repeatedly performed in a constant cycle (and at an equal frequency) on all of the power supplies 20, 30, 40, 50 and 60, which are control targets.

FIG. 3 shows exemplary frequency control by a parameter (frequency) which is set to the parameter setting unit (frequency setting unit) P.

The PWM control circuit 11 corresponding to the DC-DC converter of the power supply 20 outputs a PWM signal via the PWM signal output terminal T1a of the control unit 10. This PWM signal is a pulse width signal according to a duty ratio (on-duty) which is set by control of the feedback loop. The PWM signal which is output to the PWM signal output terminal T1a is input to the DC-DC converter via the PWM signal input terminal T21 of the power supply 20. The DC-DC converter of the power supply 20 outputs, for example, a direct-current voltage for the CPU obtained by decreasing an input voltage, in accordance with the pulse width of the PWM signal which is input to the PWM signal input terminal T21. This direct-current voltage is supplied to the CPU, which serves as a load. A detected current value (a current value detected by the current detector 115a provided in an output current path) and a detected voltage value (an output voltage value detected by the voltage detector 116a) of the power supply 20 then are input (fed back) to the control input terminals T1b and T1c of the control unit 10 via the current value output terminal T22 and the voltage value output terminal T23, respectively.

The control unit 10 controls (variably adjusts) the pulse width of the PWM signal which is supplied to the power supply 20 based on the fed back values of the control input terminals T1b and T1c at a control timing in accordance with the control frequency which is set by the parameter. That is, the control unit 10 performs pulse width control (on-duty control) of the PWM control circuit which supplies (applies) the PWM signal to the DC-DC converter of the power supply 20.

Similarly, the PWM control circuit 12 corresponding to the DC-DC converter of the power supply 30 outputs a PWM signal via the PWM signal output terminal T2a of the control unit 10. This PWM signal is input to the DC-DC converter via the PWM signal input terminal T31 of the power supply 30. The DC-DC converter of the power supply 30 outputs, for example, a direct-current voltage for a device obtained by decreasing an input voltage, in accordance with the pulse width of the PWM signal which is input to the PWM signal input terminal T31. This direct-current voltage is supplied to the device which serves as a load. A detected current value and a detected voltage value of the power supply 30 then are input (fed back) to the control input terminals T2b and T2c of the control unit 10 via the current value output terminal T32 and the voltage value output terminal T33, respectively.

The control unit 10 controls the pulse width of the PWM signal which is supplied to the power supply 30 based on the fed back values of the control input terminals T2b and T2c at a control timing in accordance with the control frequency which is set by the parameter (that is, the control unit 10 performs pulse width control of the PWM control circuit which supplies the PWM signal to the DC-DC converter of the power supply 30).

As for the power supplies 40, 50 and 60, PWM control similar to that of the power supply 30 is performed at respective control timings.

In controlling each of the power supplies 20, 30, 40, 50 and 60 by the control unit 10, in the case where, as shown in FIG. 3, a parameter is set which controls the power supply 20 for supplying power to the CPU 2 at a control frequency twice that of the power supplies 30, 40, 50 and 60 for supplying power to system component devices, pulse width control for the power supply 20 is performed twice (blocks A1 and A2), while pulse width control is performed once for each of the power supplies 30 (device output 1), 40 (device output 2), 50 (device output 3), and 60 (device output 4) (blocks B, C, D and E).

As mentioned above, by controlling the power supply (CPU 1 output) 20 for the CPU, requiring a fast response (operating at a high speed), more frequently than the other power supplies 30, 40, 50 and 60, the cross-over frequency of the feedback loop of the power supply (CPU 1 output) 20 becomes higher than those of the other power supplies 30, 40, 50 and 60. Hence, it is possible to respond to a rapid change of load with an economically advantageous configuration using a low-speed DSP, without using a high-speed DSP (or a high-speed processor) in the control unit 10.

In the above-mentioned embodiment shown in FIG. 3, the multiple-output power supply is divided into two groups (a group including the power supply (CPU 1 output) 20 and a group including the power supplies 30, 40, 50 and 60), and is controlled by using two levels for the respective groups (control frequency of the power supply unit 20: control frequency of the power supplies 30, 40, 50 and 60=2:1). However, the present invention is not limited to the above example. It is also possible to divide the multiple-output power supply into three or more groups, and to control each of the groups at a different frequency. For example, in the case where three output power supplies A, B and C are provided, and it is necessary to increase the cross-over frequencies of feedback loops for the output power supplies A, B and C in the order of A, B and C, control is performed such that control frequencies for output power supplies A, B and C satisfy A>B>C.

As mentioned above, in a multiple-output power supply, by controlling an output power supply requiring a fast response more frequently than the other output power supplies, it is possible to stably control all of the output power supplies without decreasing the cross-over frequencies of feedback loops. The invention is effective in the cases, for example, where a power supply is switched at a high speed and where the processing capacity of a processing unit (a DSP, a microcomputer, etc.) is relatively low.

According to the above-mentioned embodiment of the invention, it is possible to suitably change and set the speed of control (or response) for each power supply in accordance with the characteristic of each load which is coupled to a multiple-output power supply. Accordingly, in a multiple-output power supply using a common power supply for a plurality of loads including a load requiring a fast response, it is possible to supply stable power to all of the loads without requiring a high-speed processor. For example, in a DSP power supply which includes a plurality of outputs and is provided in a personal computer, by more frequently controlling a power supply which supplies an operating power to a CPU requiring a fast response than the other power supplies, it is possible to efficiently and stably perform control without decreasing the cross-over frequency of a feedback loop.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first DC-DC converter which outputs power to a first device and detects a first current value and a first voltage value of the first DC-DC converter;
a second DC-DC converter which outputs power to a second device and detects a second current value and a second voltage value of the second DC-DC converter;
a first PWM control circuit which supplies a first PWM signal to the first DC-DC converter;
a second PWM control circuit which supplies a second PWM signal to the second DC-DC converter; and
an operation unit configured to control a pulse width of the first PWM signal based on the first current value and the first voltage value at a first frequency, and control a pulse width of the second PWM signal based on the second current value and the second voltage value at a second frequency, the first frequency being higher than the second frequency.

2. The information processing apparatus according to claim 1, further comprising:
a frequency setting unit which sets the fist control frequency and the second control frequency.

3. The information processing apparatus according to claim 1, wherein the operation unit controls the pulse width of the first PWM signal and the pulse width of the second PWM signal in a predetermined order.

4. An information processing apparatus, comprising:
a plurality of DC-DC converters each supplying power to a corresponding device and detecting a current value and a voltage value of a corresponding one of the DC-DC converters;
a plurality of PWM control circuits each supplying a PWM signal to a corresponding one of the DC-DC converters, the PWM control circuits being divided into a plurality of groups and a different control frequency being set to each of the groups; and
an operation unit configured to control, for each of the groups, a pulse width of the PWM signal of each of the PWM control circuits based on the current value and the voltage value of the corresponding one of the DC-DC converters and the control frequency set to the group.

5. The information processing apparatus according to claim 4, further comprising:
a frequency setting unit which sets the different control frequency for each of the groups.

6. The information processing apparatus according to claim 5, wherein the PWM control circuits are divided into a first group and a second group, and the frequency setting unit sets a first frequency for the first group and a second frequency for the second group, the first frequency being higher than the second frequency.

7. The information processing apparatus according to claim 4, wherein the operation unit controls the plurality of groups of the PWM control circuits in a predetermined order.

8. A power supply control method for an information processing apparatus including a first PWM control circuit supplying a first PWM signal to a first DC-DC converter which outputs power to a first device and a second PWM control circuit supplying a PWM signal to a second DC-DC converter which outputs power to a second device, the power supply control method comprising:
setting a first frequency at which a pulse width of the first PWM signal is controlled and a second frequency at which a pulse width of the second PWM signal is controlled, the first frequency being higher than the second frequency; and
controlling the pulse width of the first PWM signal based on the first frequency and the pulse width of the second PWM signal based on the second frequency.

9. The power supply control method according to claim 8, wherein controlling the pulse width of the first PWM signal and the pulse width of the second PWM signal comprises:
detecting a first current value and a first voltage value of the first DC-DC converter and a second current value and a second voltage value of the second DC-DC converter; and
controlling the pulse width of the first PWM signal based on the first current value, the first voltage value, and the first frequency, and the pulse width of the second PWM signal based on the second current value, the second voltage value, and the second frequency.

10. The power supply control method according to claim 8, wherein controlling the pulse width of the first PWM signal and the pulse width of the second PWM signal comprises:
controlling the pulse width of the first PWM signal and the pulse width of the second PWM signal in a predetermined order.
